(19) United States
(12) Patent Application Publication
(10) Pub. No.: US 2014/0082980 A1
(43) Pub. Date: Mar. 27, 2014

(54) CABLE/TUBE LABELING TAG

(71) Applicants: Alan E. Sherman, Clayton, MO (US); Neil E. Koenig, Maryland Heights, MO (US)

(72) Inventors: Alan E. Sherman, Clayton, MO (US); Neil E. Koenig, Maryland Heights, MO (US)

(21) Appl. No.: 14/030,190

(22) Filed: Sep. 18, 2013

Related U.S. Application Data
(60) Provisional application No. 61/705,434, filed on Sep. 25, 2012.

(51) Int. Cl. G09F 3/08

(52) U.S. Cl. CPC G09F 3/08
USPC 40/316; 40/662

(57) ABSTRACT

A labeling tag for transmission lines, such as flexible electronic or electric cables or flexible fluid tubing, line comprises a body having a front surface, a back surface and a side edge with an inscribable area either or both of the back and front surfaces. Engagement members extend in opposite directions from the side edge and secure the tag to the transmission line. The engagement members comprising a frame defining a substantially enclosed area sized to receive the transmission line and which is shaped such that the transmission line is wedged between edges of said enclosed area when said tag is applied to a transmission line.

### CROSS-REFERENCE TO RELATED APPLICATIONS

This application claims priority to U.S. Prov. App. No. 61/705,434 which was filed on Sep. 25, 2012, and which is incorporated herein by reference.

### STATEMENT REGARDING FEDERALLY SPONSORED RESEARCH OR DEVELOPMENT

Not Applicable.

### BACKGROUND OF THE INVENTION

There are many situations in which numerous cords, cables or tubes are used in close proximity to each other which connect components that are spaced far apart or which are in a cluttered environment. In some circumstances, different components may be in different rooms, or some components may be indoors and some may be outside. In all these situations, it can be difficult to easily follow the cord or tube, and it thus becomes difficult to determine which cord or tube is which without following the cord or tube from one interconnection to the other. For example, a typical computer installation may well have cords for the power supply, the monitor, the printer, the mouse (or other pointing device), the keyboard, as well as many other peripheral products, such as scanners, external hard drivers, etc. When installing all these cables in the back of a computer, it can be difficult to distinguish between them, requiring the user to follow the cord to its source, so that it can be determined what the cord is for. Similar issues may occur when connecting the components of an entertainment system or in laboratories where several fluid (i.e., liquid and/or gas) tubes are used, for example, in a specific project. Additionally, labeling can be important when fluid tubes are used in conjunction with electrical wiring/cabling.

In view of the very wide range of sites and circumstances where a complex array of transmission lines such electric and electronic wires, cords or cables, fiber optic cables, tubing and even pipes, are employed in a wide variety of environments for the transmission of power, data, imagery, and even liquids and gases which, at times, may be toxic, it is important that persons working on installations and service in such environments are able to have ready visual access to information that identifies the function, flow direction and any cautionary issues related to each line, wire, cable, tube, pipe, etc. (referred to as transmission lines). This becomes even more important when system service work is being done among a very complex array of transmission lines in an environment that may be dark, dirty and/or cluttered.

### BRIEF SUMMARY OF THE INVENTION

Briefly stated, a labeling tag for a flexible transmission line comprises a body with at least one engagement member extending from a side edge of the body to mount or connect the tag to the flexible transmission line. The tag includes at least one, and preferably two engagement members. If there are two engagement members, the two engagement members extend in opposite directions from each other (i.e., extend from opposed side edges of the body).

The tag body has an inscribable area on one or both of the front and back surfaces of the body. In addition to the inscribable area, the tag can include an area for a promotional message. The inscribable area can be set off from the promotional message area, for example, by a border or by being raised or sunken relative to the promotional message area. Additionally, a directional pointer can be provided on the body to indicate the direction of flow of fluid in a tube when the tag is applied to the tube, the direction of a current or signal direction when the tag is applied to an electric wire, or the direction of transmission of light when the tag is applied to a fiber optic cable.

The engagement member comprises a frame defining a substantially enclosed area sized to receive the transmission line. The frame comprises a first leg and a second leg each of which extend from the edge of the body. The second leg is spaced from the first leg and includes a slot extending through the leg. The second leg is flexible such that the slot can be opened to admit the transmission line into the enclosed area. The slot is not perpendicular to the axis of the leg, and preferably forms an angle of about 45° with an axis of said second leg of said frame. Further, although the slot can be straight, it preferably defines a generally S-shaped curve.

The engagement member frame defines an apex at a distal end of the engagement member. Thus, the substantially enclosed area is shaped such that the transmission line is wedged between edges of the enclosed area when the tag is applied to a transmission line. For example, the substantially enclosed area defined by the frame can be generally triangular.

The frame can also be provided with a rib extending along one or both of an upper and lower surface of the engagement member frame.

The tag can additionally include a one channel extending inwardly from the edge of the body between the first and second legs of the engagement member frame. The channel is generally aligned with the apex of the frame, and thus the area of the substantially enclosed area which wedges a transmission line when the tag is applied to the transmission line. The channel can be provided with a plurality of axially extending ribs which engage the transmission line when the tag is mounted to transmission line. These ribs will engage the soft surface of the transmission line to substantially prevent rotation of the tag relative to the transmission line.

### BRIEF DESCRIPTION OF THE SEVERAL VIEWS OF THE DRAWINGS

FIG. 1 is a front perspective view of a labeling tag;

FIG. 2 is a rear perspective view of the labeling tag;

FIG. 3 is a rear plan view of the labeling tag;

FIG. 4 is a front plan view of the labeling tag; and

FIG. 5 is a side elevational view of the labeling tag.

FIGS. 6A and 6B are front and back perspective views, respectively, of an alternative embodiment of the labeling tag in use with a fluid line;

FIGS. 7A and 7B are front and back perspective views, respectively, of the labeling tag of FIGS. 6A and 6B in use with an electrical line or cable; and

FIG. 8 is a perspective view of a plurality of electrical lines/cables labeled with the labeling tag of FIGS. 6A and 6B.

Corresponding reference numerals will be used throughout the several figures of the drawings.

### DETAILED DESCRIPTION OF THE INVENTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what we presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

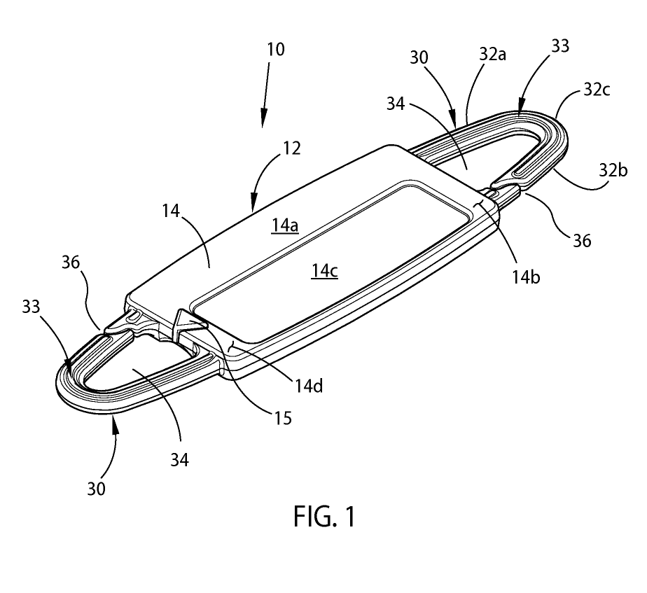

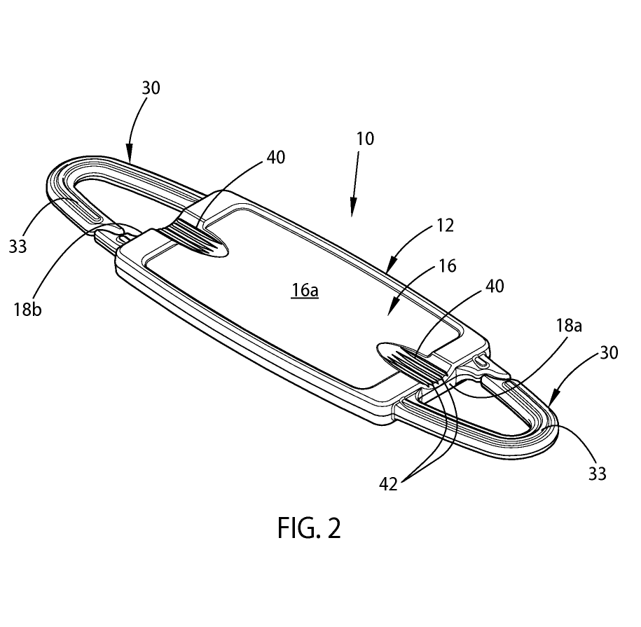

A labeling tag 10 for use with flexible linear transmission lines L (such as electric lines or wires, cables, tubing, piping, etc.) is shown generally in FIGS. 1-5. The tag 10 is preferably molded from a plastic as a one-piece or single-piece product. The plastic from which the tag 10 is molded is preferably inscribable. As will be described below, the tag 10 can be quickly and easily affixed in a parallel relationship anywhere along the length of a variety of flexible transmission lines so that the dedicated function, flow direction and other relevant information, including any necessary cautionary issues, will be visually available during installation and subsequent service work.

The tag 10 comprises a body 12 having a front surface 14 and a back surface 16. The body 12 is shown to be generally rectangular with opposed end edges 18a,b and opposed side edges 20a,b. Although shown as rectangular, the tag body could be any desired shape. The tag surfaces have satin finishes so that they will readily accept information that can be written on them with the user's choice of a pen, marker or pencil so, that appropriate needed information about the transmission line to which the tag is applied can be made readily available anywhere along the length of the transmission line. The tag can be molded such that just one surface or both surfaces are inscribable. Obviously, if both the front and back surfaces are inscribable, more detailed information can be placed on the tag.

The tag front surface 14 has two discreet areas or locations 14a,b that can be used for displaying imprinted and/or molded in messages. The area 14a is intended to be used primarily for promotional message imprinting, and can be printed or molded, for example, with a supplier's name, logo, etc. The manner in which the tag is mounted to cords, tubing, etc. enables this first area 14a to be visible whenever information written on the tag is being reviewed. The second area 14b is at one end of the tab body 12 and is generally perpendicular to the area 14a, such that the areas 14a and 14b define an overall L-shaped area of the body front surface 14. This second area can be dedicated to a more subtle message that would identify the source of the tag so that users could more readily contact that source to purchase additional tags when needed. This might even be done with a mold insert so the supplier source name could be readily changed as needed.

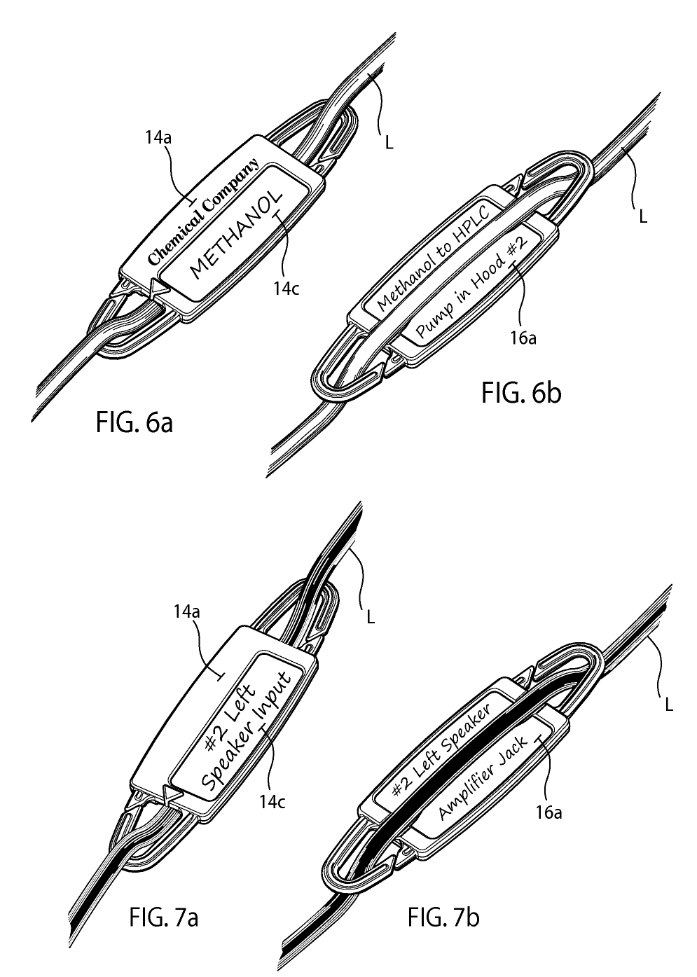

Further, the tag front surface 14 includes an inscribable area 14c where the user can write information regarding the linear transmission line to which the tag 10 is mounted, as best seen in FIGS. 6A and 7A. At least this portion of the front surface has a satin finish, as noted, which can be written upon. The areas 14a and 14b, which will not generally be written upon by a user, can have any desired finish. The labeling or informational area 14c is set apart from the rest of the front surface of the tag body (and from the areas 14a,b which border the labeling area on two sides). The labeling area 14c can be set apart from the rest of the body by being raised or lowered relative to the rest of the body, or by being surrounded by a frame (such as a small raised rib or small sunken groove). The labeling area 14c could even be defined by a printed border. As shown in the Figures, the area 14c is sunken, lowered, or depressed relative to the areas 14a,b of the tag front surface. One or both of the areas 14a and 14b can be omitted if desired, to increase the size of the inscribable informational area 14c.

Lastly, the tag front surface includes a pointer or arrow 15 in an area 14d of the front surface opposite the area 14b. The pointer 15 is molded into the tag, and, as best seen in FIGS. 1 and 5, the top surface of the pointer 15 is raised relative to the rest of the body front surface 15. This makes the pointer 15 more visible. The pointer 15 could also be printed on the front surface, or defined by a depression or by a ridge or channel formed on the front surface. The tag 10 can be mounted to a transmission line which carries fluids (such as a liquid or gas tube, line or pipe) or which transmits an electric current such that the arrow indicates the direction of flow of the liquid, gas, electric current or light through the transmission line. This can be especially convenient if the fluid transmission line is relatively long, and the tag is spaced relatively far from either end of the fluid transmission line. Although the arrow or pointer 15 is formed on the body front surface, it could instead be formed on the back surface. Alternatively, pointers could be formed on both the front and back surfaces of the body.

The body back surface 16 similarly has an inscribable labeling area 16a. The area 16a preferably has a satin finish for writing upon. The area 16a, like the inscribable labeling area 14c, is offset or set apart from the rest of the back surface by being raised or lowered relative to the rest of the body, or by being surrounded by a frame (such as a small raised rib or small sunken groove, or a printed border). The labeling area 16a is slightly smaller than the back surface 16. That is, the edges defining the boundaries of the labeling area 16a are set in only slightly from the edges 18a,b and 20a,b of the tag body. Thus, the back labeling area 16a is larger than the front labeling area 14c. Examples of information written in the labeling area 16a are shown in FIGS. 6B and 7B.

To mount the tag 10 to a linear transmission line, the tab 10 includes an engagement fixture 30 extending from each end edge 18a and 18b of the tab body. Hence, the two engagement fixtures 30 extend in opposite directions. Although shown extending from opposite ends of the tag body 12, the engagement fixtures could extend from adjacent edges (e.g., edges 18a and 20a). Although two engagement fixtures are shown and preferred, the tag 10 could be formed with just a single engagement fixture 30. The engagement fixtures 30 are identical (and mirror images of each other) and are sized and shaped to accommodate a wide range of typically used linear transmission line. Illustratively, engagement fixtures 30 are defined by a generally triangular frame 32 having first and second leg 32a,b which extend from the end edge of the body in an angled manner and are joined at a generally rounded apex 32c spaced from the body end edge. The engagement fixtures could also be defined as being generally catenary or parabolic in shape. As seen in FIG. 5, the engagement fixtures 30 have a top-to-bottom depth which is less than the top-to-bottom depth of the body 12. A rib or ridge 33 is formed on the upper and lower surfaces of the frame 32. Although shown on both the top and bottom surfaces of the frame 32, the rib 33 could be formed on only one surface of the frame 32.

The frame 32 defines a generally triangular, catenary or parabolic opening 34 through which cables, lines, tubing, etc. extends, as seen in FIGS. 6A-8, with a distal, apical, or free end that is narrower than the base of the frame. The shape of the frame, and more particularly, the shape of the opening 34, is such that the linear transmission line will be wedged between the edges of the opening 34 at the apical, distal, or free end of the opening 34. Although the opening 34 is shown as generally triangular in shape, it could be formed to have other shapes.

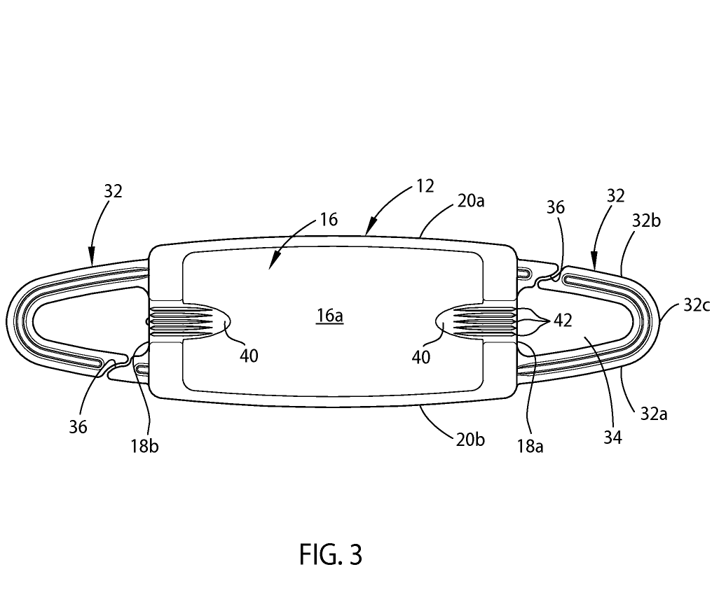

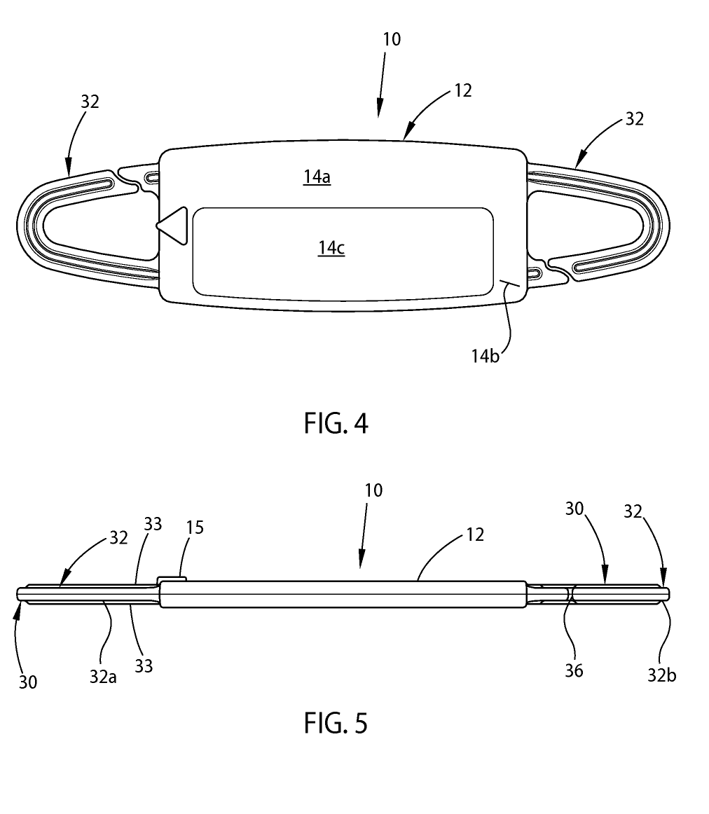

A slot 36 is formed in the leg 32b of each engagement fixture 30. Because the engagement fixtures 30 are mirror images of each other, the slots 32b are on opposite sides of the tag. That is, one slot is on the same side of the tab as body edge 20a and the other slot is on the same side as the body edge 20b. The slots 36 each define an S-curve (as best seen in FIGS. 3 and 4) which is angled to be, on average, about 45° from a parallel relationship to the frame 32 (i.e., about 45° relative to an axis of the frame leg 32b). The overall angle of the slot 36 relative to the frame leg makes the slot 36 about 50% longer than it would be if the slot were in a more typical perpendicular relationship to the axis of the frame leg. Further, the curvature of the slot 36 increases the length of the slot relative to a straight slot (such as seen in tags of FIGS. 6A-7B). The shape of the slot will reduce the likelihood that the transmission line will slip out of the engagement member, and thus further enhance an ongoing fixed relationship between the tag and the linear transmission line, especially when service work is being done that involves actively moving the transmission line. The slots 36 could also be straight, as shown in FIGS. 6A-7B. As best seen in FIG. 5, the opening to the slot 36 on the outer edge surface of the frame leg 32b is arcuate. The S-shape and angle of the slots 36 make it less likely that the transmission line will slip out of the engagement fixtures. With the S-shape and the angle of the slot, any lateral pressure from the transmission line on which the tag has been installed will tend to close the gap in the frame leg 32b formed by the slot 36, rather than opening the gap which would have let the transmission line slip out of the engagement fixture.

The material (i.e., plastic) from which the tag 10 (or at least the engagement fixtures 30) are made allows portion of the frame leg 32b between the slot 36 and the frame distal end 32c to flex, such that the slot 36 can be opened to admit the transmission line into the opening or area 34 defined by the frame 32. Once the tag is installed on a transmission line, the engagement fixtures automatically flex to a closed position to help maintain engagement of the tag in the location along the line where it has been installed. The requirement that the engagement member frame leg be flexed to open the slots 36 reduces the potential for accidental disengagement of the tag 10 from the transmission line. The ridge 33 increases the durability and resiliency of the engagement fixture frame to return to its original unflexed position after being installed on a transmission line.

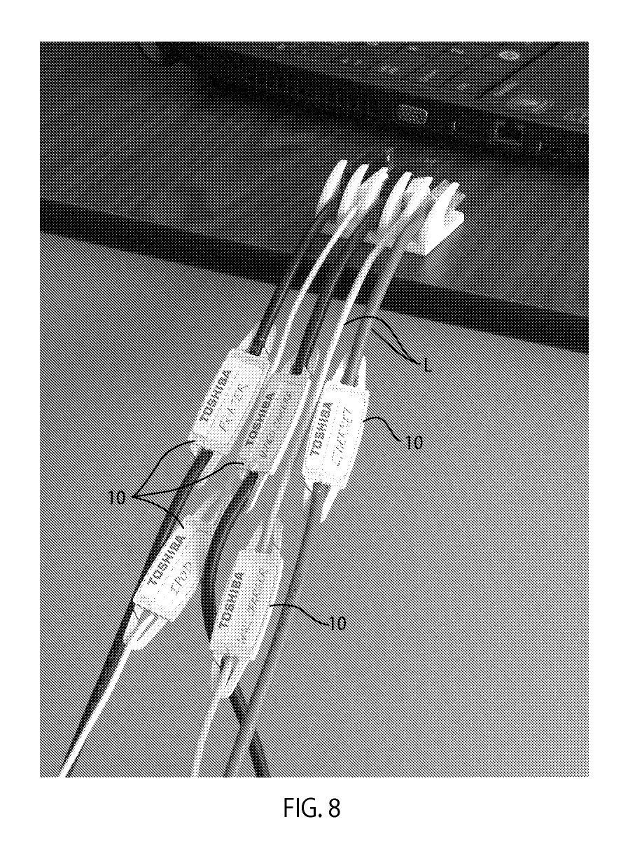

The tag body 12 includes tapered indents or channels 40 on its back surface 16. The channels 40 extend inwardly from the end edges 18a,b into the labeling area 16a, and are generally centered along the body edges 18a,b to be generally aligned with the apex 32c of the engagement member frames 32. As seen, the channels 40 generally define a portion of an elongate oval in plan view. The channels help maintain the linear transmission line in a centered parallel interrelationship with the tag 10. This interrelationship between the transmission line and the tag is further enhanced by a series of generally parallel sharp linear edges or ribs 42 molded into each of the channels 40. These ribs further engage the generally flexible material from which the transmission line is typically made to maintain the rotational position of the tag on the transmission line (i.e., to prevent the tag 10 from rotating relative to the transmission line). Thus, when the tag is installed it can be adjustably oriented for optimum visual access with good assurance that it will remain so positioned, no matter how much the linear transmission line may be moved, and will help assure good visual access to all the information presented on a group of tags installed on an array of such line at a given location (for example, as seen in FIG. 8).

The triangular shape of the area 34 defined by the engagement fixture frames 32 help maintain the linear transmission line within the engagement fixture 30 in a position that tends to keep the linear line away from the engagement slots when there might be any active movement of the linear transmission line. This becomes even more apparent when it is seen that the apexes 32c of the engagement member frames 32 are aligned with the channels 40, such that the transmission line will extend over the channels 40 and under the apexes 32c in a straight line, as best seen FIGS. 6B and 7B. The engagement member thus helps to prevent accidental disengagement of the tag from the transmission line during movement of the transmission line.

Additionally, when the tag 10 is installed on a transmission line (which is generally flexible), the flexible resilience of the transmission line will tend to cause the transmission line to straighten as it passes through the engagement fixture frames 32, and will cause the transmission line to wedge within the triangular area 34 defined by the frames 32, at the narrowed apex of the area 34. This wedging action of the transmission line in the frames 32 reduces the potential from movement of the tag on the transmission line relative to its installed location on the transmission line. This wedging function could be achieved with other frame configurations, and thus the frames 32 do not necessarily need to define a generally triangular area 34. Thus, the use of two engagement members 30 with two engagement openings 34 helps prevent disengagement of the tag from the transmission line. If there is any movement of the transmission line that accidentally disengages the tag at one of the engagement members, the other engagement member will continue to hold the tag. However, if desired, the tag 10 could be formed with a single engagement member 30.

The tag 10 is an inexpensive, single piece product that can simultaneously be manufactured in multiples by employing plastic injection molding or die cutting. The tags can be readily made from recycled materials, further enhancing their appeal to persons who have environmental concerns.

The tag is premade from a resilient material that requires its users to force or flex open the slots 36 in the engagement fixtures 30 at each end when either installing or removing the tag. The tag 10 has been configured to satisfy needs in a wide range of different markets including, but not limited to, consumer use for visual, audio, computer component and accessory connections. These same applications are appropriate for use with both business and professional performance venues like offices, theatres, night clubs, auditoriums, etc. It is also appropriate for use in industrial applications and scientific research laboratories where multiple electrical lines, fiber optic cables, fluid and gas flow tubes are frequently intermixed with one another in the same area or over long distances.

The tags 10 can be provided in multiple colors so if users want to, they can dedicate individual colors to specific identification requirements, which will further enhance quick and easy information transmission to users. Since the tags are made from molded plastic they can also be made available in materials that will glow in the dark, making them easier to access in a dark environment.

The tags, as generally defined, are size dedicated to the most commonly used diameters of single linear transmission line. The same physical design configuration can also be enlarged to provide all the same features and functions for much larger diameter linear transmission line like bundle sets of multiple lines or even rigid pipes through which a variety of fluids or gases may be flowing at dedicated different temperatures identifiable on the tag.

Because of their easy installation and removal, the tags can even be employed temporarily for certain short term applications.

In view of the above, it will be seen that the tag 10 can be easily and quickly applied to a transmission line to temporarily or permanently label the transmission line.

As various changes could be made in the above constructions without departing from the scope of the invention, it is intended that all matter contained in the above description or shown in the accompanying drawings shall be interpreted as illustrative and not in a limiting sense. For example, the engagement members 30 need not be triangular. They could be pentagonal, or define a semi-oval. However, no matter the shape, it is desirable that the engagement members come to, or define, an apex or point at its distal end to help maintain the position of the transmission line and the tag relative to each other. The slots 36 could be formed on the same side, rather than on opposite sides, of the tag. Although on the front surface 14, the arrow 15 could be formed on the back surface 16. These examples are merely illustrative.

1. A labeling tag for transmission line comprising:
a body having a front surface, a back surface and a side edge; and
at least one engagement member extending from said side edge; said engagement member comprising a frame defining a substantially enclosed area sized to receive the transmission line; said frame comprising:
a first leg extending from said edge;
a second leg extending from said edge spaced from said first leg;
said second leg including a slot extending through said leg; said second leg being flexible such that said slot can be opened to admit transmission line into said enclosed area; and
an apex at a distal end of said engagement member.

2. The tag of claim 1 wherein said slot forms an angle of about 45° with an axis of said second leg of said frame.

3. The tag of claim 1 wherein said slot defines a generally S-shaped curve.

4. The tag of claim 1 wherein said substantially enclosed area is shaped such that the transmission line is wedged between edges of said enclosed area when said tag is applied to a transmission line.

5. The tag of claim 4 wherein said substantially enclosed area defined by said frame is generally triangular.

6. The tag of claim 1 including a rib extending along one or both of an upper and lower surface of said engagement member frame.

7. The tag of claim 1 including at least one channel extending inwardly from said edge between the first and second legs of said engagement member frame.

8. The tag of claim 7 wherein said channel is generally aligned with an area of said substantially enclosed area which wedges a transmission line when said tag is applied to the transmission line.

9. The tag of claim 7 wherein said channel includes a plurality of axially extending ribs which engage said transmission line when the tag is mounted to transmission line to substantially prevent rotation of said tag relative to said transmission line.

10. The tag of claim 1 including an inscribable area on one or both of said back surface and said front surface.

11. The tag of claim 1 including a promotional message area on said front surface.

12. The tag of claim 11 including an inscribable area on said front surface; said inscribable area being set off from said promotional message area.

13. The tag of claim 1 wherein said engagement member is a first engagement member; said tag including a second engagement member spaced along said side edge from said first engagement member; said second engagement member being substantially identical to said first engagement member.

14. The tag of claim 13 wherein said first and second engagement members extend in opposite directions from each other.

15. The tag of claim 1 further including a directional pointer for indicating the direction of flow of fluid in a tube when the tag is applied to the tube.

16. A labeling tag for transmission line comprising:
a body having a front surface, a back surface and a side edge; said body including an inscribable area on one or both of said back surface and said front surface; and
a pair of engagement members extending from said side edge; said engagement members extending in opposite directions from each other; each said engagement member comprising a frame defining a substantially enclosed area sized to receive the transmission line; said substantially enclosed area being shaped such that the transmission line is wedged between edges of said enclosed area when said tag is applied to a transmission line; said frame comprising:
a first leg extending from said edge; and
a second leg extending from said edge spaced from said first leg;
said second leg including a slot extending through said leg; said second leg being flexible such that said slot can be opened to admit transmission line into said inner area.

17. The tag of claim 16 wherein said slot forms an angle of about 45° with an axis of said second leg of said frame.

18. The tag of claim 16 wherein said slot defines a generally S-shaped curve.

19. The tag of claim 16 wherein said substantially enclosed area defined by said frame is generally triangular.

20. The tag of claim 16 including at least one channel extending inwardly from said edge between the first and second legs of said engagement member frame; said channel being generally aligned with the area of said substantially enclosed area which wedges a transmission line when said tag is applied to the transmission line.

21. The tag of claim 20 wherein said channel includes a plurality of axially extending ribs which engage said transmission line when the tag is mounted to transmission line to substantially prevent rotation of said tag relative to said transmission line.

22. The tag of claim 16 further including a directional pointer for indicating the direction of flow of fluid in a tube when the tag is applied to the tube, the direction of transmission of an electric current when the tag is applied to an electric wire, or the direction of light transmission when the tag is applied to a fiber optic cable.
